(19) United States
(12) Patent Application Publication
(10) Pub. No.: US 2008/0237412 A1
(43) Pub. Date: Oct. 2, 2008

(54) DISPLAY DEVICE STAND

(75) Inventors: Motonari Chinuki, Chiba (JP); Yoshihiko Kato, Chiba (JP); Kazunori Sukeda, Tokyo (JP)

Correspondence Address: HARNESS, DICKEY & PIERCE, P.L.C., P.O. BOX 828, BLOOMFIELD HILLS, MI, 48303, US

(73) Assignee: THE BANK OF TOKYO-MITSUBISHI UFJ, LTD., Tokyo (JP)

(21) Appl. No.: 11/938,813

(22) Filed: Nov. 13, 2007

(30) Foreign Application Priority Data
Mar. 26, 2007 (JP) 2007-79516

(51) Int. Cl. F16M 11/00

(52) U.S. Cl. 248/123.2

(57) ABSTRACT

There is provided a display device stand used with a long table used in a TV conference, the display device stand allowing each of attendees seated along the long table to accurately see the contents displayed on the display screen of the display device. A display device stand 1 for supporting a display device 30 includes a base 2, a column 12 standing on the base 2, and a supporting member 20 provided at the column 12 and supporting the display device 30. The column 12 stands at a position on the opposite side of the center of the base 2 from the display screen of the supported display device 30. A weight 10 is removably attached to the base 2. The mass of the weight 10 added to the base 2 enhances the stability of the base 2, so that the display device 30 can be supported in a stable manner.

### BACKGROUND OF THE INVENTION

1. Field of the Invention

The present invention relates to a display device stand that is effective in supporting a panel display device, such as a liquid crystal monitor.

2. Description of the Related Art

In recent years, there have been provided various TV conference systems using networks, and they have been widely used, for example, when panel display devices, such as liquid crystal monitors, are used to hold a TV conference between attendees at locations remote from each other.

For example, Japanese Patent Laid-Open No. 2004-229051 discloses, as an exemplary panel display device that can be used in such TV conference systems, a stand including a leg formed into a cross shape, a column that is provided at the upper center of the leg and stands perpendicular thereto, and casters attached at a plurality of locations on the underside of the leg. Japanese Patent Laid-Open No. 2004-229051 also discloses an example in which a panel display device is attached to the upper end of the column of the stand.

A TV conference between attendees at locations remote from each other using display devices, each having such a configuration, can be held, for example, by placing a long table at a predetermined position in a room or the like, seating attendees at the front side of the long table, placing display devices on the rear side of the long table in correspondence with the attendees, and showing the attendees the contents displayed on the display screens of the individual display devices. In this way, the attendees participate in the TV conference.

### SUMMARY OF THE INVENTION

In the display device having such a configuration described above, since the column stands at the center of the leg of the stand and the display device is attached to the upper end of the column, when the display device placed on the rear side of the long table is brought closer to the front side of the long table, the column abuts the rear side edge of the long table, so that the display device cannot be brought closer to the front side of the long table any more. The display screen of the display device is thus located at a position remote from the attendee seated on the front side of the long table. It is therefore difficult for the attendee to accurately see the contents displayed on the display screen of the display device, thus preventing the TV conference from smoothly proceeding.

Furthermore, since the leg will jut out from the rear side edge of the long table by a large amount, when the attendees move around the long table, the attendees may accidentally kick the leg and bring the display device down.

The present invention has been made in view of the conventional problems described above and aims to provide a display device stand used with a long table used in a TV conference, the display device stand allowing each of attendees seated along the long table to accurately see the contents displayed on the display screen of the display device, and having no risk that the attendees accidentally bring the display device down when the attendees move around the long table.

To solve the above problems, the present invention employs the following means.

That is, in the invention, a display device stand for supporting a display device includes a base, a column standing on the base, and a supporting member provided at the column and supporting the display device. The column stands at a position on the opposite side of the center of the base from the display screen of the supported display device, and a weight is removably attached to the base.

With the display device stand according to the present invention, for example, when a long table is used to hold a TV conference, by seating attendees on the front side of the long table, placing display devices on the rear side, and bringing the display devices toward the front side of the long table in such a way that the columns abut the rear side edge of the long table, most part of the bases can be pushed in under the long table, so that the display devices can be located above the long table in such a way that they overhang toward the front side of the long table.

In this way, since the display screens of the display devices can be brought closer to the attendees seated on the front side of the long table, the attendees can accurately see the contents displayed on the display screens of the display devices, thus allowing the TV conference to smoothly proceed. Furthermore, for each of the display device stands, since the length of the base jutting out from the long table can be reduced on the rear side of the long table, when the attendees move around the long table, the attendees will not accidentally kick the base and bring the display device down. Moreover, although the column stands at a position on the opposite side of the center of the base from the display screen of the display device, the weight attached to the base allows the mass of the weight to be added to the base, the stability of the base can be enhanced, thus allowing the display device to be supported in a stable manner.

In the invention, the weight may be removably attached to the underside of the base.

In the display device stand according to the present invention, since the weight attached to the underside of the base increases the mass of the base, so that the center of gravity of the entire display device stand including the display device can be shifted downward. The stability of the entire display stand including the display device is therefore enhanced, so that the length of the supporting legs can be reduced.

In the invention, casters that can roll and pivot on the floor may be attached to the lower part of the base, and the weight may be removably attached in the space that the casters create under the base.

In the display device stand according to the present invention, since the weight can be attached using the space that the casters create under the base, by changing the number of weights according to the display device being used, various display devices can be supported in a stable manner.

In the invention, the supporting member may be a hinge having two blades that can swing with respect to each other, and by disposing one or more hinges on the top of the column, fixing one of the blades of the hinge to the top of the column, and fixing the other blade to the rear side of the display device, the display device can swing integrally with the other blade, and the display device can be angularly adjusted between the position where the display screen of the display device is oriented upward and the position where the display screen of the display device is oriented horizontally.

In the display device stand according to the present invention, the other blade of the hinge swings relative to the one of the blades, so that the display device swings integrally with the other blade and is adjusted to the angle corresponding to the swing position of the other blade. In this case, the display device can be adjusted at an arbitrary angular position between the position where the display screen of the display device is oriented upward and the position where the display screen of the display device is oriented horizontally.

In the invention, when the display device is angularly adjusted in such a way that the display screen is oriented horizontally, the hinge may have a torque greater than the rotational torque acting on the display device.

In the display device stand according to the present invention, since the hinge has a torque greater than a rotational maximum torque acting on the display device, when the display device is adjusted to an arbitrary angle, the display device can be reliably held at that position.

As described above, with the display device stand according to the present invention, for example, when a long table is used to hold a TV conference, by seating attendees on the front side of the long table, placing display devices on the rear side in correspondence with the attendees, and bringing the display devices toward the front side of the long table in such a way that the columns abut the rear side edge of the long table, most part of the bases can be pushed in under the long table, so that the display devices can be located above the long table in such a way that they overhang toward the front side of the long table.

In this way, since the display screens of the display devices can be brought closer to the attendees, the attendees can accurately see the contents displayed on the display screens, thus allowing the TV conference to smoothly proceed.

Furthermore, since the length of the base jutting out from the edge of the long table can be reduced, when the attendees move around the long table, the attendees will not accidentally kick the base and bring the display device down.

### BRIEF DESCRIPTION OF THE DRAWINGS

FIG. 1 is a front view showing the entirety of an embodiment of the display device stand according to the present invention;

FIG. 2 is a side view of FIG. 1;

FIG. 3 is a plan view of FIG. 1;

FIG. 4 is a front view of the display device stand with a column extended;

FIG. 5 is a side view of FIG. 4;

FIG. 6 is a side view of the display device stand with its display device inclined at approximately 45 degrees;

FIG. 7 is an enlarged view of the rear side of the display device;

FIG. 8 is a plan view of FIG. 7;

FIG. 9 is an enlarged view showing the display device with its display screen angularly adjusted to be oriented horizontally;

FIG. 10 is an enlarged view showing the display device with its display screen angularly adjusted to be inclined at approximately 45 degrees;

FIG. 11 is an enlarged view showing the display device with its display screen angularly adjusted to be oriented upward;

FIG. 12A is a plan view of a hinge;

FIG. 12B is a side view of FIG. 12A;

FIG. 12C is a front view of FIG. 12A;

FIG. 13 is a schematic layout diagram of display devices when a TV conference is held; and

FIG. 14 is an enlarged side view of FIG. 13.

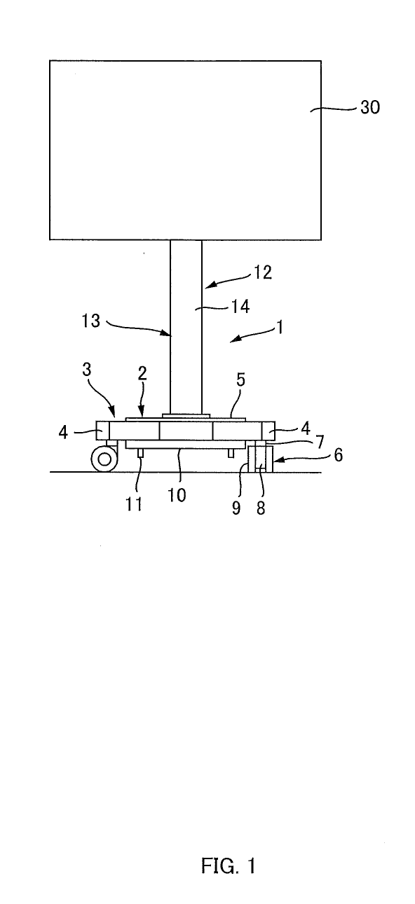

### DETAILED DESCRIPTION OF THE PREFERRED EMBODIMENT

An embodiment of the present invention will be described below with reference to the drawings.

The display device stand 1 shown in the present embodiment is applied to various TV conference systems using networks, and, for example, effective in supporting a panel-type display device, such as a liquid crystal monitor, when such a display device is used to hold a TV conference between locations remote from each other with a number of attendees on both sides. The display device stand 1 includes a base 2 pivotable and movable in four directions, forward and rearward as well as rightward and leftward, on the floor of a room or the like, a column 12 provided on the upper side of the base 2 and standing perpendicular thereto, an attachment portion 16 provided integrally with the top of the column 12, and supporting member 20 attached to the attachment portion 16. A display device 30 is attached to the supporting member 20.

The base 2 includes a leg 3, a substrate 5 provided integrally with the upper side of the leg 3, casters 6 attached to the underside of the leg 3, and a weight 10 removably attached to the underside of the substrate 5. The column 12 perpendicularly stands on the upper side of the substrate 5. The longitudinal and lateral dimensions of the base 2 are smaller than the width of the display screen of the display device 30.

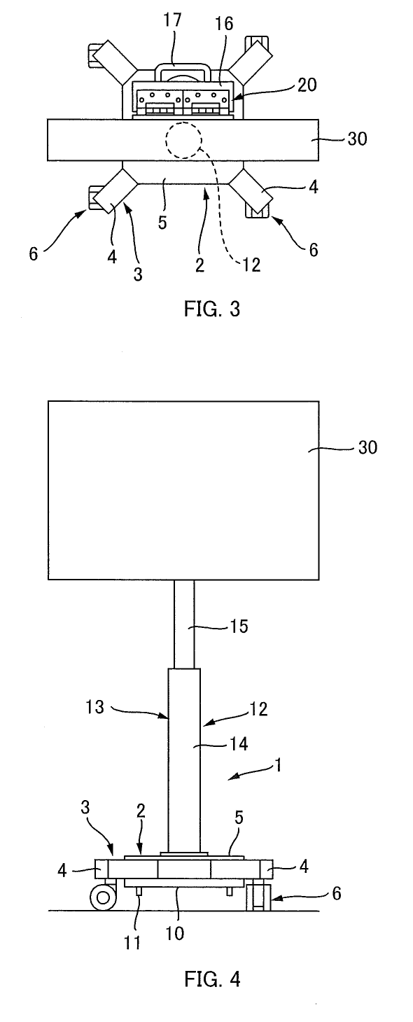

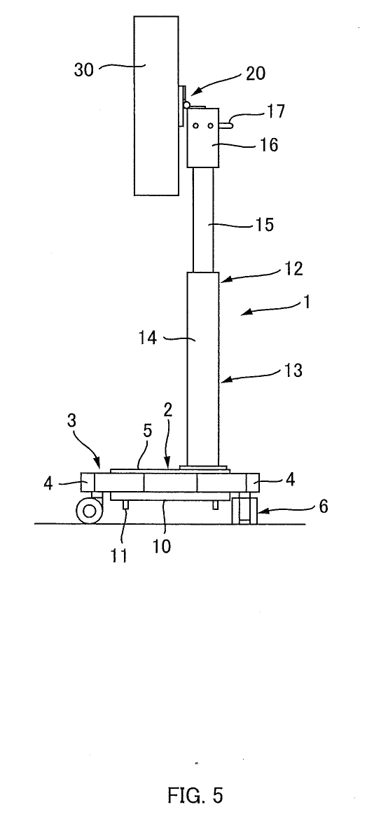

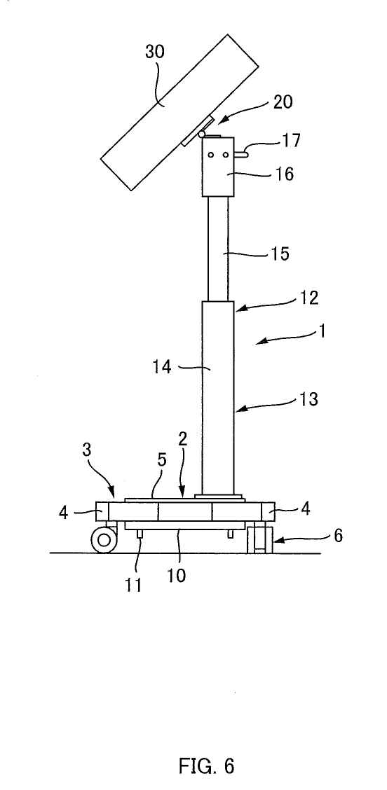

The leg 3 is formed by combining four supporting legs 4 crosswise, as shown in FIG. 3. The rectangular plate-like substrate 5 is integrally connected to the upper center of the combined supporting legs 4 using welding or the like, and the column 12 perpendicularly stands on the substrate 5 in such a way that the column 12 is located behind the display screen of the display device 30.

Each of the casters 6 is attached to the underside of the end of each supporting leg 4 of the leg 3, and these casters 6 support the base 2, the column 12 standing on the base 2, and the display device 30 attached to the top of the column 12 via the supporting member 20 and allow them to integrally pivot and move in four directions, forward and rearward as well as rightward and leftward, on the floor.

The caster 6 is a commercially available caster and includes a base section 7 secured to the underside of each supporting leg 4 with screws (not shown), a support section 8 pivotably provided under the base section 7, a shaft (not shown), the central part of which is supported by the support section 8, and a wheel 9 rotatably supported by the shaft via bearings (not shown). When each of the wheels 9 rotates around the shaft and pivots by following the pivotal movement of the support section 8, the base 2, the column 12 and the display device 30 will integrally move in four directions, forward and rearward as well as rightward and leftward, on the floor and pivot on the floor.

The caster 6 is not limited to the one configured as described above, but may be various other commercially available types. The supporting legs 4 of the leg 3 are not also limited to the cross shape but may be formed in other shapes.

The weight 10 is, for example, made of metallic material, such as lead, and shaped into a plate with a uniform density. The weight 10 is removably attached to the center of the underside of the substrate 5 with screws 11. By adding the mass of the weight 10 to the underside of the substrate 5, it is possible to increase the mass of the base 2 and shift the position of the center of gravity of the entire display device stand 1 including the display device 30 downward. The stability of the entire display device stand 1 including the display device 30 is therefore enhanced, so that the display device 30 supported above the base 2 via the column 12 can be supported in a stable manner and the length of each supporting leg 4 can be reduced.

In this case, the space formed under the underside of the substrate 5 is used to attach the weight 10. Therefore, by changing the number of weights 10 according to the mass, the position of the center of gravity and the like of the display device 30 being used, the base 2 can support various display devices 30 different in mass, position of center of gravity and the like from each other in a stable manner.

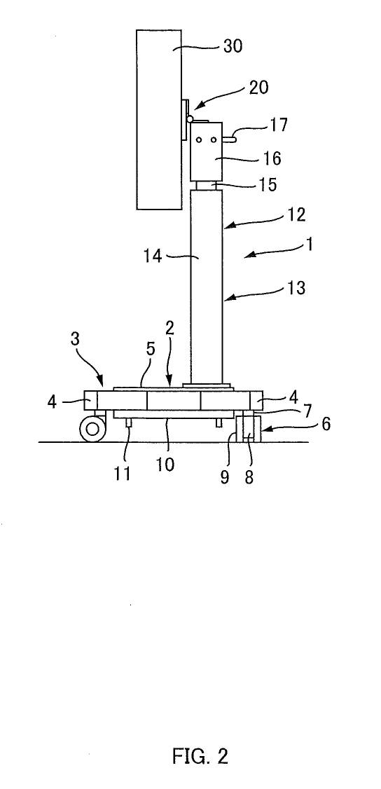

The column 12 perpendicularly stands at a position displaced from the center of the substrate 5 to the rear side of the display screen of the display device 30 (rightward in FIG. 2). The attachment portion 16 is provided integrally with the top of the column 12, and the display device 30 is attached to the attachment portion 16 via the supporting member 20.

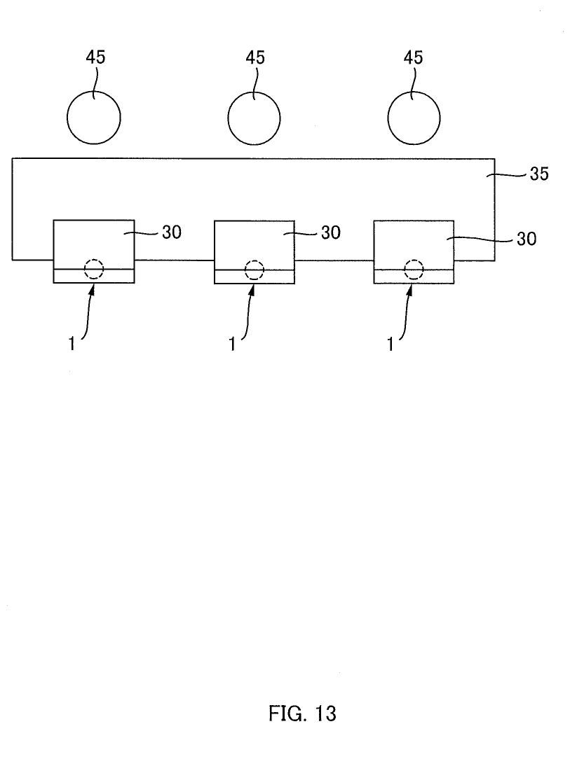

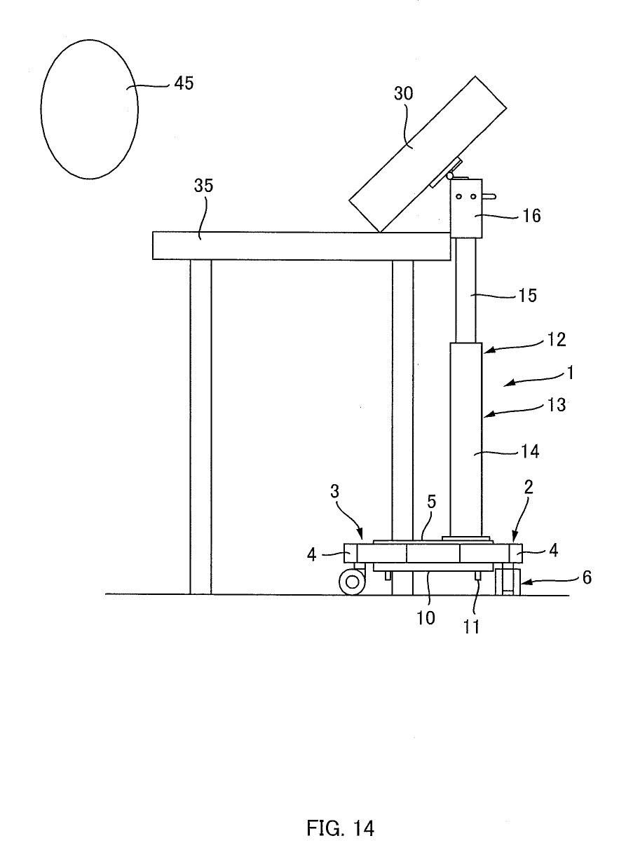

The column 12 stands at a position displaced from the center of the substrate 5 to the rear side of the display screen of the display device 30 in order to make the length from the column 12 to the front end of the base 2 longer than the length from the column 12 to the rear end of the base 2. The column 12 standing at such a position allows the front portion of the base 2 to be pushed in under the long table 35 when the long table 35 is used to hold a TV conference, as shown in FIGS. 13 and 14, thus reducing the length of the base 2 that juts out from the long table 35.

The column 12 has an extendable vertical height adjustment mechanism 13. By using the height adjustment mechanism 13 to extend or retract the column 12 in the vertical direction, it is possible to adjust the vertical position of the display device 30 attached to the attachment portion 16 at the top of the column 12 via the supporting member 20.

In the present embodiment, the column 12 with the height adjustment mechanism 13 is a commercially available air suspension including a cylinder body 14 and a reciprocately movable rod 15 in the cylinder body 14. In this case, the lower end of the cylinder body 14 of the air suspension is secured to the upper side of the substrate 5 of the base 2 with screws, and the display device 30 is attached via the supporting member 20 to the upper side of the box-like attachment portion 16 provided integrally with the upper end of the rod 15.

The attachment portion 16 is not limited to the box shape, but may be formed in other shapes such as a plate.

A U-shaped handle 17 is provided integrally with the rear side (the right side in FIG. 2) of the attachment portion 16 in such a way that the handle 17 juts out from the rear. By holding the handle 17 by hand and vertically moving the rod 15, the display device 30 can be brought to the position corresponding to the vertical position of the rod 15.

A locking mechanism (not shown) that secures the rod 15 at a predetermined vertical position is provided between the cylinder body 14 and the rod 15. By using the locking mechanism to secure the rod 15, it is possible to secure the display device 30 attached to the rod 15 via the attachment portion 16 at an arbitrary vertical position.

The column 12 is not limited to the air suspension, but may be other mechanisms as long as they have an extendable vertical height adjustment mechanism 13.

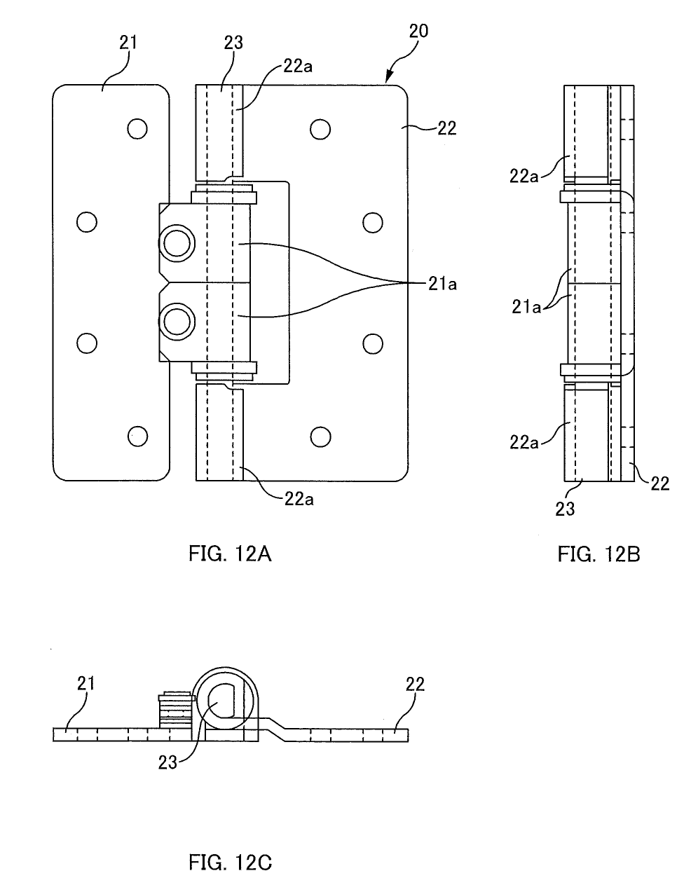

The supporting member 20 is a hinge 20 including two rectangular plate-like blades 21 and 22, sleeves 21a and 22a provided integrally with the edges of the longer sides of the blades 21 and 22, respectively, and a connecting rod 23 that connects the sleeves 21a of the blade 21 with the sleeves 22a of the blade 22 in such a way that the sleeves 21a and 22a can rotate with respect to each other, as shown in FIG. 12. In such a configuration, the two blades 21 and 22 can swing with respect to each other within a predetermined angular range around the connecting rod 23.

The hinge 20 is adjusted in such a way that the rotational torque necessary to swing the blades 21 and 22 is greater than a maximum torque generated by the display device 30, as will be described later.

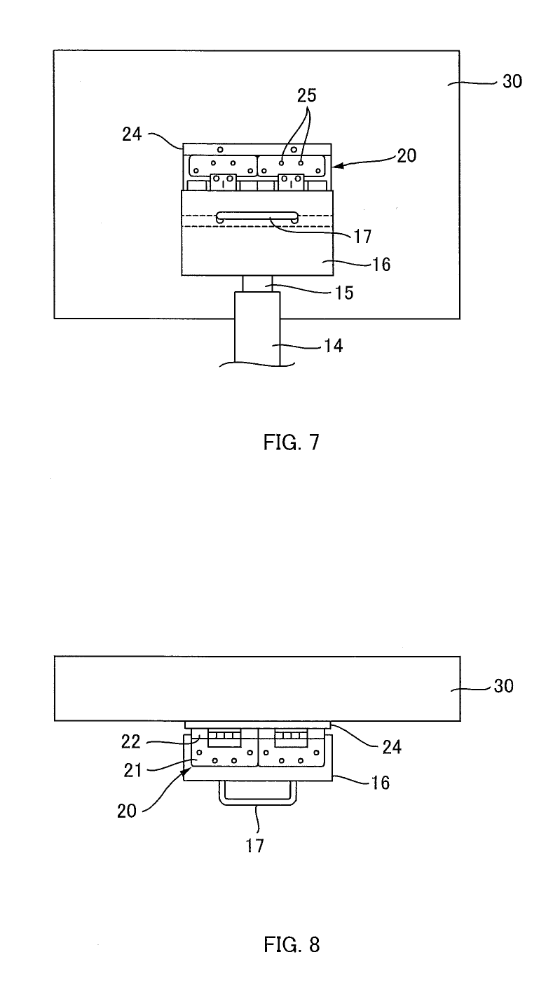

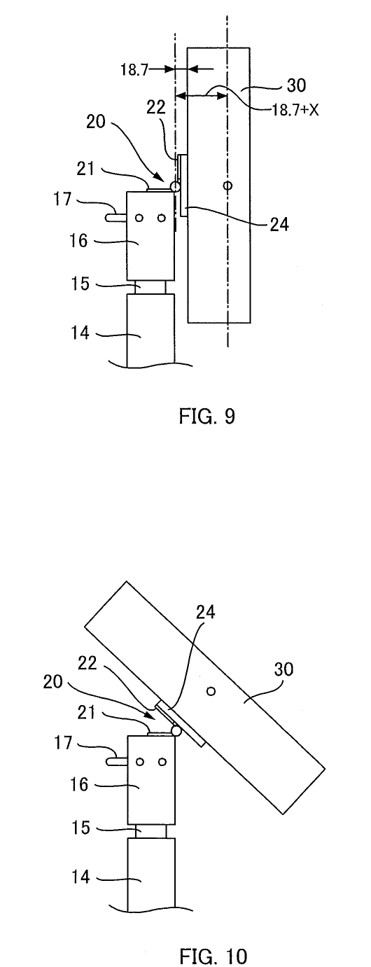

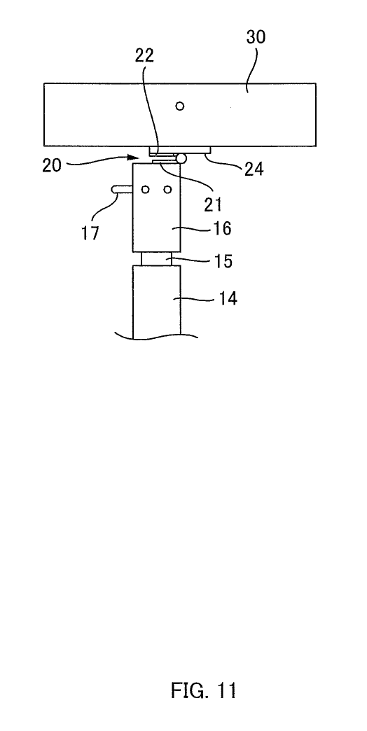

In the present embodiment, as shown in FIGS. 7 and 8, two hinges 20 are disposed in series on the upper side of the attachment portion 16. For each of the hinges 20, one of the blades of the hinge 20, the blade 21, is fixed to the upper side of the attachment portion 16 with screws 25, while the other blade 22 is fixed to the center of the rear side of the display device 30 via a plate 24 with the screws 25. The display device 30 thus swings integrally with the other blades 22 of the hinges 20 above the attachment portion 16. In this way, the display device 30 can swing between the position where the display screen is oriented upward (the position where the other blades 22 are at their closed positions) and the position where the display screen is oriented horizontally (the position where the other blades 22 are angled substantially at 90 degrees with respect to the blades 21, each of which is called one of the blades in the above description), and the display device 30 can be adjusted at an arbitrary angle between these two positions.

With the display device 30 angularly adjustable within the range described above, as shown in FIGS. 13 and 14, for example, when the display device 30 is placed on the rear side of the long table 35 and the base 2 is pushed in under the long table 35 in such a way that the column 12 abuts the rear side edge of the long table 35, the display device 30 can jut toward the front side of the long table 35 thereabove by a large amount, so that the display screen of the display device 30 can be closer to the TV conference attendee 45 seated on the front side of the long table 35.

The hinge 20 is configured in such a way that when the display device 30 is angularly adjusted to an arbitrary position, the hinge 20 has a torque greater than the rotational torque acting on the hinge 20 generated by the mass of the display device 30 at the adjusted position. In this way, the hinge 20 reliably holds the display device 30 at an arbitrary position. That is, since a maximum rotational torque acts on the hinge 20 at the position where the display screen of the display device 30 is oriented horizontally, the hinge 20 is selected to have a torque greater than the rotational torque acting on the display device 30 at that position. Use of the hinge 20 having such a torque allows the display device 30 to be reliably held at an arbitrary position.

In the present embodiment, the display device 30 is a 24-inch liquid crystal monitor having a weight of 9 kg, for example. The rotational torque acting on the display device 30 measured at the position where the display screen of the display device 30 is oriented horizontally was approximately 6.95 Nm, which was a maximum torque. The hinge 20 having a torque greater than this rotational torque (approximately 9.2 Nm) was therefore selected and used.

In the present embodiment, although two hinges 20, each having a torque of approximately 4.6 Nm, disposed in series are used, one hinge 20 or more than two hinges 20 may be used to ensure a torque of 9.2 Nm.

The display devices 30, each attached to the display device stand 1 having the above configuration according to the present embodiment, are used to hold a TV conference between attendees remote from each other, as shown in FIGS. 13 and 14, for example, by placing the long table 35 at a predetermined position in a room, seating the attendees 45 along the long table 35 on the front side thereof, and placing the display devices 30, the number of which corresponds to the number of attendees, on the rear side of the long table 35.

By moving each of the display devices 30 and the display device stand 1 that supports it on the floor to bring them closer toward the front side of the long table 35, and pushing the front portion of the base 2 of the display device stand 1 under the long table 35 in such a way that the column 12 abuts the rear side edge of the long table 35, the display device 30 is located above the long table 35.

Then, by extending or retracting the column 12 to adjust the height of the display device 30, swinging the display device 30 to adjust the inclination angle thereof, allowing the display device 30 to overhang toward the front side of the long table 35, and bringing each of the attendees closer to the display screen of the display device 30, the display screen of the display device 30 is adjusted to be visible to the attendee 45.

In this case, the column 12 stands at a position behind the display screen of the display device 30 remote from the center of the base 2. However, since the weight 10 having a predetermined weight corresponding to the display device 30 being used is attached to the underside of the substrate 5 of the base 2, the mass of the weight 10 can be added to the base 2 and the center of gravity of the base 2 can be shifted downward, so that the stability of the base 2 can be enhanced and the display device 30 can be adjusted at any angle and supported in a stable manner.

Furthermore, when the display device 30 is located above the long table 35, the column 12 can be extended or retracted to adjust the vertical position of the display device 30 in such a way that the lower end of the display device 30 abuts the upper side of the long table 35. This allows reduction in the rotational moment acting on the display device 30, so that the display device 30 can be held at an adjusted angle in a more stable manner.

By placing the display devices 30 in correspondence with the respective attendees 45 participating in the TV conference as described above, the TV conference can proceed while the attendees look at the contents displayed on the display screens of the display devices 30.

In the display device stand 1 having the configuration described above according to the present embodiment, since the column 12 stands at a position behind the display screen of the display device 30 remote from the center of the base 2 and the display device 30 is attached to the top of the column 12 via the hinge 20, most part of the base 2 can be pushed in under the long table 35 when the long table 35 is used to hold a TV conference. Therefore, even when the attendees 45 participating in the TV conference move around the long table 35, the attendees 45 will not accidentally kick the base 2 and bring the display device 30 down.

Since the display device 30 attached to the top of the column 12 via the hinge 20 can swing between the position where the display screen is oriented upward and the position where the display screen is oriented horizontally as well as be adjusted at an arbitrary angle between these positions, when the base 2 is pushed in under the long table 35 in such a way that the column 12 abuts the edge of the long table 35, the display screen can overhang toward the attendee 45 above the long table 35. Since the display screen of the display device 30 can therefore be brought closer to the attendee, the attendee 45 can accurately see the contents displayed on the display screen of the display device 30, allowing the TV conference to smoothly proceed.

In the above description, although the hinge 20 is used as the supporting member for adjusting the angle of the display device 30, the supporting member is not limited to the hinge 20, but may be other means as long as they have a function capable of adjusting the display device 30 at a predetermined angle and holding the display device 30 at that position.

Furthermore, in the above description, although the column 12 with the height adjustment mechanism 13 is used, a column with no height adjustment mechanism may be used.

What is claimed is:

1. A display device stand for supporting a display device, comprising:
a base;
a column standing on the base; and
a supporting member provided at the column and supporting the display device,
wherein the column stands at a position on the opposite side of the center of the base from the display screen of the supported display device, and a weight is removably attached to the base.

2. The display device stand according to claim 1, wherein the weight is removably attached to the underside of the base.

3. The display device stand according to claim 1, wherein casters that can roll and pivot on the floor are attached to the lower part of the base, and the weight is removably attached in the space that the casters create under the base.

4. The display device stand according to claim 2, wherein casters that can roll and pivot on the floor are attached to the lower part of the base, and the weight is removably attached in the space that the casters create under the base.

5. The display device stand according to claim 1, wherein the supporting member is a hinge having two blades that can swing with respect to each other, and by disposing one or more hinges on the top of the column, fixing one of the blades of the hinge to the top of the column, and fixing the other blade to the rear side of the display device, the display device can swing integrally with the other blade, and the display device can be angularly adjusted between the position where the display screen of the display device is oriented upward and the position where the display screen of the display device is oriented horizontally.

6. The display device stand according to claim 2, wherein the supporting member is a hinge having two blades that can swing with respect to each other, and by disposing one or more hinges on the top of the column, fixing one of the blades of the hinge to the top of the column, and fixing the other blade to the rear side of the display device, the display device can swing integrally with the other blade, and the display device can be angularly adjusted between the position where the display screen of the display device is oriented upward and the position where the display screen of the display device is oriented horizontally.

7. The display device stand according to claim 3, wherein the supporting member is a hinge having two blades that can swing with respect to each other, and by disposing one or more hinges on the top of the column, fixing one of the blades of the hinge to the top of the column, and fixing the other blade to the rear side of the display device, the display device can swing integrally with the other blade, and the display device can be angularly adjusted between the position where the display screen of the display device is oriented upward and the position where the display screen of the display device is oriented horizontally.

8. The display device stand according to claim 4, wherein the supporting member is a hinge having two blades that can swing with respect to each other, and by disposing one or more hinges on the top of the column, fixing one of the blades of the hinge to the top of the column, and fixing the other blade to the rear side of the display device, the display device can swing integrally with the other blade, and the display device can be angularly adjusted between the position where the display screen of the display device is oriented upward and the position where the display screen of the display device is oriented horizontally.

9. The display device stand according to claim 5, wherein when the display device is angularly adjusted in such a way that the display screen is oriented horizontally, the hinge has a torque greater than the rotational torque acting on the display device.

10. The display device stand according to claim 6, wherein when the display device is angularly adjusted in such a way that the display screen is oriented horizontally, the hinge has a torque greater than the rotational torque acting on the display device.

11. The display device stand according to claim 7, wherein when the display device is angularly adjusted in such a way that the display screen is oriented horizontally, the hinge has a torque greater than the rotational torque acting on the display device.

12. The display device stand according to claim 8, wherein when the display device is angularly adjusted in such a way that the display screen is oriented horizontally, the hinge has a torque greater than the rotational torque acting on the display device.
